(19) United States
(12) Patent Application Publication
(10) Pub. No.: US 2009/0094797 A1
(43) Pub. Date: Apr. 16, 2009

(54) Paper clip

(76) Inventor: Arsenio P. Santos, JR., Aloha, OR (US)

Correspondence Address: Timothy E. Siegel, Suite 1900, 601 108th Ave NE, Bellevue, WA, 98004-4376, US

(21) Appl. No.: 12/284,439

(22) Filed: Sep. 22, 2008

Related U.S. Application Data
(63) Continuation of application No. 10/502,738, filed on Jul. 26, 2004.
(60) Provisional application No. 60/353,402, filed on Feb. 1, 2002.

(51) Int. Cl. B42F 1/02

(52) U.S. Cl. 24/67.9

(57) ABSTRACT

A method of clipping papers together, to be performed by a user, that utilizes a paper clip made of resilient material and defining a paper clip plane when the resilient material is in its relaxed state, the paper clip includes a torsion bridge linking an inner jaw and an outer jaw. The inner jaw further includes a gap catch extending from a closed end of the inner jaw whereby the gap catch is disposed in a generally offset position in relation to the outer jaw and wherein one end of the gap catch is closely adjacent to a portion of the torsion bridge. The user holds the clip, pressing against the gap catch with a digit, to move the inner jaw out of the paper-clip plane and slides the papers into the gap created and releases the gap catch, so the clip transversely presses against and thereby retain the papers.

### RELATED APPLICATIONS

This application is a continuation of application Ser. No. 10/502,738, filed Jul. 26, 2004, which is a national phase application from international application PCT/US03/02966 filed Jan. 31, 2003, which claimed priority from U.S. Provisional Application No. 60/353,402, entitled AN IMPROVED PAPER CLIP, filed on Feb. 1, 2002, the entire disclosure of which is hereby incorporated by reference as if set forth in its entirety for all purposes.

### BACKGROUND OF THE INVENTION

This invention relates to binders for stacked paper and specifically to paper clips made from a single length of rigid material with some degree of resilience.

Paper clips have been around for more than a century, and the commonest form commercially available is not necessarily the best but mainly the cheapest, according to popular observation. There is a pervading need to improve on the current design. The conventional double oval design, also known as the gem clip, has been especially targeted for improvements by inventors the world over. However, it is still perceived to be the best compromise of all the desirable qualities even though it has its share of design problems, which until the present invention have not been adequately overcome by those attempting improvements. Accordingly there is a substantial need for an improved paper clip that has the one or more of the following qualities: strong gripping power; low risk of ripping or tearing papers; will not tangle up with other paper clips in the box; easy and comfortable to use; will not fly off when made to engage thicker stacks of papers; better holding capacity relative to raw materials used; free from risk of physical injury; allows more options for manufacturing different sizes; repeat usability especially for bigger size clips; aesthetically pleasing design; cheap and easy to manufacture.

Among the disadvantages of a conventional clip such as the gem clip is the clip's propensity for tearing papers while being removed. This problem arises because the free ends of the clip are set at a lower position. This becomes more significant with the smaller size paper clips in which are the free ends are set even much lower.

Specific attempts have been made to overcome this shortcoming. For example, U.S. Pat. No. 5,329,672 discloses a large gem clip having preferred dimensions of three (3) inches to five (5) inches in overall length. Of particular interest is the length of the free ends, which extend beyond a tangent point on the closed loop portion. However, this design has several shortcomings. For instance, the relatively long gripping jaws reduce gripping force. This is compensated by both increasing the overall length and increasing the cross-sectional (or heavier gauge) diameter of the resilient material The increase in overall length provides increased frictional contact area, while the increased cross-sectional area of the wire increases the resiliency of the material. This solution is wasteful, as the need for additional raw materials are required to attain satisfactory gripping properties.

Other known problems with conventional clips are their tendency to unexpectedly and suddenly release as a user attempts to engage it with thicker stacks of papers. This may subject the user to eye injury or other discomfort. Also, a stack of paper just a few pages thick may permanently deform the prior art clips beyond their resilient threshold. This may render the clip ineffective at retaining the paper or otherwise destroy its usability.

Apparently nothing in the market today has a better mix of the desirable qualities. Thus, the gem paper clip continues to enjoy its dominance in the market. The solution chosen by some manufacturers is to produce a cloned type of gem clip by economizing on raw materials. However, as the price becomes all the more a determining factor in sales, the more undesirable the prior-art clip becomes. This practice has resulted in the proliferation of many poor quality gem clips in the market today.

Several attempts have been made over the years to improve the paper clip. One such attempt is to strengthen the grip by increasing frictional contact. U.S. Pat. No. 2,269,649 to Comley (1942) makes use of elongated loop-shaped jaws (identified by reference numbers 7, 9 in the '649 patent), to achieve this goal. However, by elongating the inner loop shaped jaw 9, the free end portion 11 is extended further upward which would make it difficult to open the clip during insertion. This is a trade off for a desired stronger grip. Consequently in order to meet this new problem a laterally offset compound curvature is needed, resulting in a clip that is not flat. This structure, although intended mainly to reduce tearing, could explain the claim of the inventor that the overall configuration of his design provides for ease of use. The added structure however triggers a new problem for which there was no answer undertaken. The laterally offset compound curvature sticks out during use (FIG. 4, '649 patent). According to the teaching of this invention, this structure is displaced as the stacks of paper becomes thicker. In this manner, tears can be prevented. But, as the structure is displaced, its tip 8 presents problems concerning risk for physical injury to the user or anyone close by. Additionally, this design is wasteful. Another problem of this design would be the tendency of the protruding structures 8 and 11 to catch unintended objects while in use and the enhanced proclivity to get tangled up with other paper clips in the box.

The prior art also discloses triangle-shaped clips in attempt to solve some shortcomings of the gem clip. Triangle-shaped clips usually have free ends that are close to the top spine or connector. This can be seen in U.S. Pat. No. 761,631 to Gorton (1904), U.S. Pat. No. 767,458 to Weiss (1904), U.S. Pat. No. 761,635 to Kelley (1904), U.S. Pat. No. 1,336,626 to Hall (1920) and U.S. Pat. No. 1,985,866 to Lankenau (1934). The triangular configuration can reduce the tendency to rip papers, but it is not easy to use. The extended free ends deprive the top spine from acting as a handle to urge open the clips when attempting to engage papers. Furthermore the above designs share in common the presence of a central gap or space. The index finger or thumb can slip through this gap making manipulation more difficult during insertion. As a result they are usually manufactured in smaller sizes such that the index finger or thumb will not pass through.

### SUMMARY OF THE INVENTION

In a first separate aspect, the present invention may take the form of a method of clipping papers together, to be performed by a user, that utilizes a paper clip made of resilient material and defining a paper clip plane when the resilient material is in its relaxed state, the paper clip includes a torsion bridge linking an inner jaw and an outer jaw. The inner jaw further includes a gap catch extending from a closed end of the inner jaw whereby the gap catch is disposed in a generally offset position in relation to the outer jaw and wherein one end of the gap catch is closely adjacent to a portion of the torsion bridge. Also, the torsion bridge and inner jaw enclose an area sufficient to accommodate a human digit. The user holds the clip with the user's digits, pressing against the gap catch with another digit of the user, thereby moving the inner jaw out of the paper-clip plane and creating a gap in dimension transverse to the paper-clip plane between the inner jaw and the outer jaw. The user slides the papers into the gap and releases the gap catch, thereby permitting the inner jaw and the outer jaw to transversely press against and thereby retain the papers.

In a second separate aspect, the present invention may take the form of a method of clipping paper together, to be performed by a user and utilizing a paper clip, made of resilient material, defining a paper-clip plane in the resilient material's relaxed state and having a first length extending in a first direction from the beginning point; a first bend, extending from the first length; a second length, extending from the first bend in a second direction offset from the first direction by about 135 degrees, an arc of about 300 degrees, extending from the second length and defining an arc terminal point, where the arc extends in an arc terminal direction; a second bend extending from the arc terminal point; and a termination length extending from the second bend in a terminal length direction that is about 110 degrees offset from the arc terminal direction, and ending at a clip terminal point. The user uses his digits to hold the clip, pressing on the termination length with a digit, thereby pushing the arc terminal point out of the paper-clip plane and creating a gap in dimension transverse to the paper-clip plane between the arc termination point and the first bend and slips the papers into the gap. The user then releases the paper clip, which permits the arc termination point and the first bend to press against and retain the papers.

### BRIEF DESCRIPTION OF THE DRAWINGS

FIG. 1 is plan view of a paper clip in accordance with the present invention.

FIG. 2 is a right side elevational view of a the paper clip of FIG. 1

FIG. 3 is a left side elevational view of the paper clip of FIG. 1.

FIG. 4 is top elevational view of the paper clip of FIG. 1.

FIG. 5 is bottom elevational view of the paper clip of FIG. 1.

FIG. 6 is another possible embodiment of a paper clip in accordance with the present invention.

FIG. 7 is plan view of another possible embodiment of a paper clip in accordance with the present invention.

FIG. 8 is a plan view of another possible embodiment of a paper clip in accordance with the present invention.

FIG. 9 is a plan view of another possible embodiment of a paper clip in accordance with the present invention.

FIG. 10a is plan view of another possible embodiment of a paper clip in accordance with the present invention.

FIG. 10b is side view of the embodiment of FIG. 10a

FIG. 10c is a top view of the embodiment of FIG. 10a

FIG. 10d is a bottom view of the embodiment of FIG. 10a

FIG. 10e is a plan view of an embodiment of a bookmark in accordance with the present invention.

FIG. 10f is a plan view of another possible embodiment of a bookmark in accordance with the present invention.

FIG. 11a is plan view of a paper clip in accordance with the present invention.

FIG. 11b is top elevational view of the paper clip of FIG. 11a.

FIG. 12a is plan view of a paper clip in accordance with the present invention.

FIG. 12b is plan view of a paper clip in accordance with the present invention.

### DETAILED DESCRIPTION OF THE INVENTION

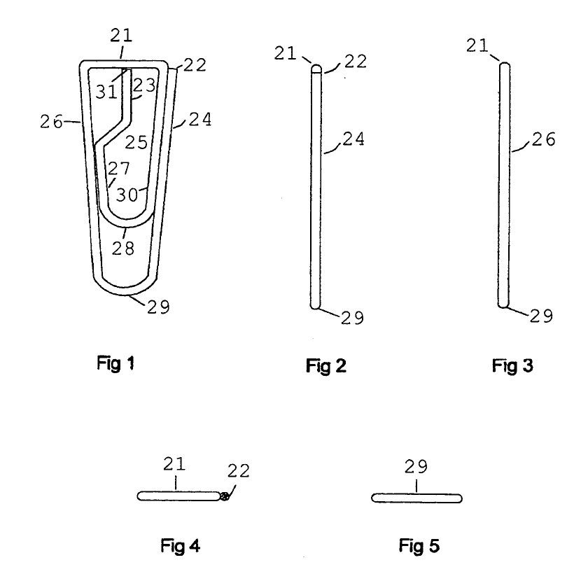

FIGS. 1-12 show embodiments of the present invention in accordance with the foregoing principles. Similar features are indicated by the same reference numeral. The present invention is generally indicated by the reference numeral 1.

The paper clip 1 generally comprises a torsion bridge 21, a gap catch 23, an inner jaw 28, and an outer jaw 29. Preferably, the inner and outer jaws 28, 29 and the torsion bridge 21 are in the same or substantially in the same plane. Torsion bridge 21 is disposed at the top of the clip. Inner jaw 28 includes, a closed inner arm 30 and an open inner arm 27. The torsion bridge 21 may be straight curved or other configuration spanning outer arm 26 and inner, arm 30. The torsion bridge 21 may include a first bend 40. Outer jaw 29, has a rounded end, and includes an open outer arm 24, an outer arm free end 22, and a closed outer arm 26. The inner jaw may include a second bend 41 and the outer jaw may include a third bend 42. Leading downwardly from the left side of the torsion bridge 21 and integral therewith is closed outer arm 26. Leading downwardly from the right side is open outer arm 24. Gap catch free end 31 is disposed at the end of open inner arm 27, substantially filling up the central gap 25 of the clip. It terminates at free end 31. The gap catch 23 can be urged from either direction by any of two opposing fingers. The outer jaw 29 is sufficiently distanced from the inner jaw 28 to promote cooperation with the gap catch 23 during insertion of paper. The outer arm 24 is adjacent to the closed inner arm 30. Closed outer arm 26 is adjacent to open inner arm 27 but may be spaced apart as in alternative embodiments. In a suitable embodiment, the outer jaw open arm 24 and the inner jaw closed end 31 are spaced apart not more than a cross-sectional diameter of width of the clip material.

Preferably sections 24 and 30 are closely adjacent. The closely adjacent sections 24 and 30 eliminate gaps that could lead to paper clips 1 entangling with one another. In a suitable embodiment the gap would typically be less than a full diameter of the material, for example between 0 and 85% of the cross sectional diameter of a round cross sectional material. The inner jaw closed end 30 and the outer jaw open end 24 each have a segment whereby each respective segment is closely adjacent to the other. These segments are substantially coplanar. In a suitable embodiment, the ends 24 and 20 are in contact. In another embodiment the ends 24 and 30 are within 3 mm.

The planarity of the clip 1 also helps in reducing the tendency of multiple clips 1 to tangle with one another. Preferably, end 31 should be closely adjacent or touching torsion bridge 21 to close gaps that could lead to entanglement. Further, such an arrangement serves to reduce risk of tearing paper because the end is located at the edge of paper. Still further, this arrangement reduces the risk of physical injury to fingers by placing the ends out of the finger contact regions. Still further, the location of the gap catch between outer arm 26 and inner arm 30 helps stabilize the paper clip 1 against lateral displacement during use.

The paper clip 1 is employed over paper by slightly pressing the gap catch 23 to create an opening for receiving paper. This makes it possible to locate the inner arm 27 closer to the torsion bridge 21. The gap catch 23 is generally offset from the outer jaw 29. In one suitable embodiment, the gap catch 23 extending from the inner jaw 28 at one end is placed diagonally across a void defined by the shape of the inner jaw 28. In another suitable embodiment, the gap catch may include a bend at an intermediate portion, thus extending from the inner jaw 28, and then proceeding generally parallel to the outer jaw 29. At the bend in the intermediate portion, the gap catch 23 would then extend away from the outer jaw 29 at the gap catch free end 31.

In one possible embodiment, gap catch free end 31 could extend to the torsion bridge 21. This, for example, could be done in plastic, producing a stronger plastic version, compensating for the generally less resilient nature of plastics relative to metals.

Paper clips according to the present invention may be manufactured and used in a wide range of sizes. They also may be effectively used at a size where conventional clips are not effective because they are hard to manipulate at the size range or are prone to deformation. For example, conventional clips of about 2.0″ long and about 0.25″ wide, which is generally the most common size for a conventional clip, have an effective capacity of about 12 pages. Beyond that number the arms of the clip tend to twist away from the surface of the pages. In contrast, a paper clip according to the present invention that is 0.75-1″ long and 0.5-0.75″ wide could hold effectively about 24-36 pages, thereby obviating the need for larger and/or more expensive clipping devices such as butterfly clips or binder clips.

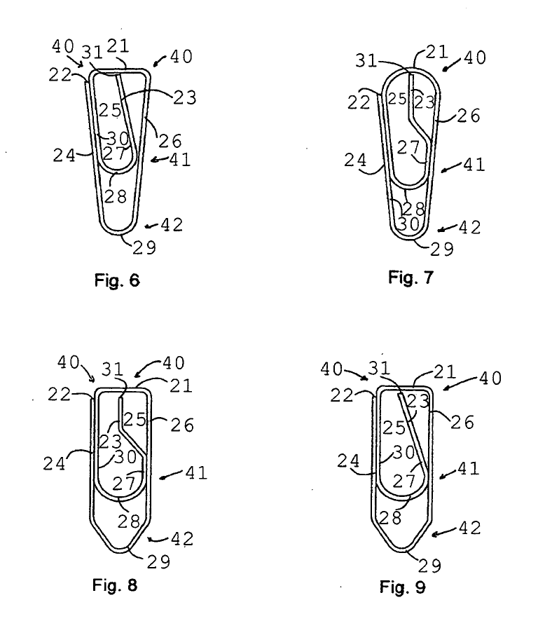

In FIG. 6, open inner arm 27 and gap catch 23 are disposed substantially in linear alignment. The linear arrangement is disposed at an acute angle relative to the longitudinal axis of the clip. The embodiment of FIG. 7 is similar to the embodiment of FIG. 1 but with a rounded top portion. The embodiment of FIG. 8 is similar to FIG. 1, but has a triangularly shaped end to outer jaw 29. The embodiment of FIG. 9 is similar to the embodiment of FIG. 6 but, inner arm 27 and gap catch 23 are in linear arrangement. It is noted that the use of a triangular top and/or bottom may use less material than the rounded version. It is also advantageous to have a general shape with downwardly converging jaw portions 28 and 29, as shown in FIGS. 1 and 6, for example. This converging design allows for less raw material during manufacture. It also reduces the likelihood of the lower portion of the clip 1 deforming away from paper, particularly where the clip 1 is used on thicker stacks of paper. The triangular bottom portion of, for example, FIGS. 8 and 9 also help produce the foregoing effects.

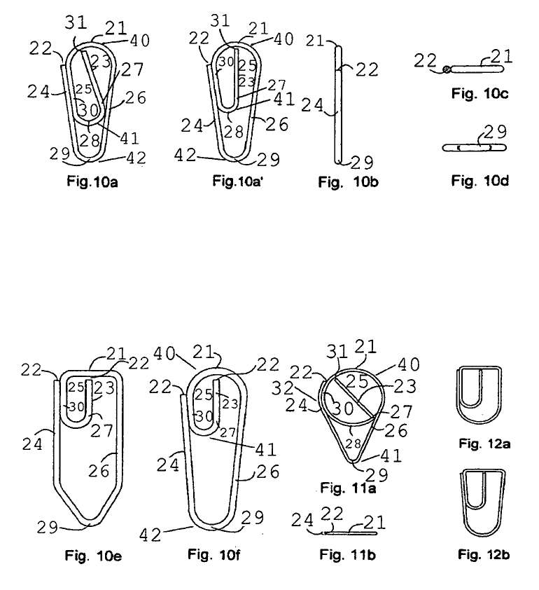

Referring specifically to FIGS. 10a, 10b, 10c, and 10d, a suitable embodiment of the present invention is shown which includes three bends. In this embodiment, the clip 1 is an economical configuration that facilitates manufacturing of the invention. As shown, a continuous length of resilient material, such as plastic, wire, spring wire, or other material known in the art, is formed in to the clip 1 of the present invention. Starting at the outer arm free end 22, a straight length of material extends therefrom, forming the open outer arm 24. A first bend is included on the outer jaw 29 at a location on the open outer arm 24. The location of the bend occurs at a point that facilitates economy of production, while optimizing a selected capacity of the clip 1. The first bend continues to round the outer jaw 29 and begins to form closed outer arm 26 at one end. At a second end of the closed outer arm 26, a second bend transitions from the closed outer arm 26 to the torsion bridge 21. The torsion bridge 21 in this embodiment is formed from a uniform diameter, which is selected based on the capacity requirements of a desired clip 1. The second bend comprises the transition from the closed outer arm 26 at one end to the closed inner arm 30 at an opposite end of the continuous length of resilient material. Extending from the torsion bridge 21, the closed inner arm 30 generally follows a path parallel to the open outer arm 24. It is understood that the inner closed arm 30 cooperates with the open outer arm 24 to define a inner closed end gap 35.

In FIG. 10a, this gap 35 is quite narrow, and contributes to the gripping force of the cooperating outer jaw 29 and inner jaw 28. However, in FIGS. 11 and 12, an alternate embodiment is shown where the gap 37 is quite large, resulting in low gripping force. In FIGS. 11 and 12, a suitable use for such an embodiment is a bookmark or other application where low gripping force is desired.

Returning to a general description of FIGS. 10a, 10b, 10c, 10d, 11 and 12, the inner closed arm 30 is connected to the torsion bridge 21 and second bend at one end. At an opposite end, the inner closed arm 30 communicates with a third bend, here the inner jaw 28. A third bend, which is included on the inner jaw 28, may be one continuous constant diameter. In this manner the third bend and inner jaw 28 transition to the open inner arm 27. It should be noted that the open inner arm 27 traverses a void defined by the inner jaw 29 cooperating with the closed inner arm 30 and closed outer arm 26. In FIG. 10a the open inner arm 27 extends at a general diagonal direction from the inner jaw 28 toward the outer arm free end 22. In this manner, the open inner arm 27 terminates at the gap catch free end 31 and cooperates with the torsion bridge 21 to create a narrow inner free end gap 33. This gap 33, in a suitable embodiment, is less than the cross sectional diameter of the resilient material so to reduce the propensity of multiple clips 1 from tangling during handling, shipping, storage and the like.

Referring again specifically to FIGS. 1-9 and 10a, it is shown that the open inner arm 27 cooperates with the closed outer arm 26 at a point near the inner jaw 28 and the third bend to create a small inner jaw gap 37. This small inner jaw gap 37 reduces the propensity of multiple clips 1 from tangling during handling, shipping, storage and the like. Additionally, this inner jaw gap 37 contributes to the gripping force of the clip 1, making the force greater.

Conversely, referring now to FIGS. 11 and 12, the inner jaw gap 37 is relatively broad. This results in a lower gripping force, and may be useful for a bookmark or other applications where lower gripping force is desired.

Surface friction created by increasing the contact area of the jaws 28, 29 to the stack of sheet material, such as paper, contrary to conventional thinking, plays less important role. More significantly, the ability to firmly grasp a stack of paper depends more on the gripping force exerted on the papers by decreasing the length of the inner and outer arms of jaws 28, 29 respectively. Of course, it is understood that, if a point is reached where the contact area becomes too small no amount of gripping force can make the paper clip hold pages effectively. Thus, an important ratio of gripping force to the overall length of the gripping arms is established.

Specifically, gripping force is related to the combination of the amount of resistive force inherent in the resilient material when twisted about its own axis. The nexus of this resistive force occurs at the torsion bridge 21 and transfers the force along the closed outer arm 26 and closed inner arm 30. It is understood, that by maintaining relatively short gripping jaws 28 and 29, the counter acting leverage force exerted by a quantity of sheet material is reduced. This counter acting leverage force works to separate the inner and outer jaw 28 and 29, thus reducing the gripping force. It should also be understood in the art that too short of a gripping jaw will result in no gripping force.

Capacity, as measured by the number of sheets of paper that can be grasped by the paper clip 1, is directly proportional to the arc length. It is understood that the torsion bridge 21 can be configured to be curved over any suitable radius. In the extreme, but suitable, configuration, the torsion bridge 21 may be straight, or otherwise defined as have a radius of 180 degrees.

It is understood in the art that it is desired to form the present invention from a resilient material. Such a material is suitable for items such as paper clips and has desirable characteristics, for example, the ability to be initially formed to a desired shape, then retain that shape after repeated deformations within normal use.

However, as the gripping jaws 28 and 29 decrease in overall length, the more difficult it becomes to manipulate and insert paper into gripping jaws 28 and 29 of the clip. To compensate for this difficulty, this invention incorporates the feature of a gap catch 23. The gap catch 23 permits a user to exert a pressure on the clip 1 to separate the jaws 28 and 29, thus facilitating easy insertion of paper. I have discovered that a gap catch 23 that is formed by the open arm 27 of the inner jaw 28 is canted so to traverse an inner space region of the inner jaw 28 at a generally diagonal direction facilitates user manipulation. Moreover, this design does not adversely affect the gripping force of the clip.

Another important aspect of this invention is the small or non-existent gaps between the inner jaw and the outer jaw particularly along the side of the outer free arm. This prevents tangling of clips when a plurality of the clips is stored. Additionally, it also enhances the gripping force and reduces the tendency of the clip to tear paper when used.

Additionally, by maintaining small or no gaps at the free ends in relation to the clip structure, there is a reduced propensity to tear paper and become entangled.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

1. A method of clipping papers together, to be performed by a user and comprising:
(a) providing a paper clip made of resilient material and defining a paper clip plane when said resilient material is in its relaxed state, said paper clip including a torsion bridge linking an inner jaw and an outer jaw; the inner jaw further including a gap catch extending from a closed end of the inner jaw whereby the gap catch is disposed in a generally offset position in relation to the outer jaw and wherein one end of said gap catch is closely adjacent to a portion of said torsion bridge;
(b) wherein said torsion bridge and inner jaw enclose an area sufficient to accommodate a human digit;
(c) while holding said clip with said user's digits, pressing against said gap catch with another digit of said user, thereby moving said inner jaw out of said paper-clip plane and creating a gap in dimension transverse to said paper-clip plane between said inner jaw and said outer jaw, sliding said papers into said gap and releasing said gap catch, thereby permitting said inner jaw and said outer jaw to transversely press against and thereby retain said papers.

2. The method of claim 26, wherein said torsion bridge and said inner jaw form an approximate ⅞ circle.

3. The method of claim 27 wherein a sharp bend separates said inner jaw from said gap catch.

4. The method of claim 26, wherein said outer jaw includes a sharp bend.

5. A method of clipping paper together, to be performed by a user and comprising:
(a) providing a paper clip, made of resilient material, defining a paper-clip plane in said resilient material's relaxed state, and comprising:
(i) a beginning point;
(ii) a first length extending in a first direction from said beginning point;
(iii) a first bend, extending from said first length;
(iv) a second length, extending from said first bend in a second direction offset from said first direction by about 135 degrees;
(v) an arc of about 300 degrees, extending from said second length and defining an arc terminal point, where said arc extends in an arc terminal direction;
(vi) a second bend extending from said arc terminal point; and
(vii) a termination length extending from said second bend in a terminal length direction that is about 110 degrees offset from said arc terminal direction, and ending at a clip terminal point;
(b) while said uses his digits to hold said clip, pressing on said termination length with a digit, thereby pushing said arc terminal point out of said paper-clip plane and creating a gap in dimension transverse to said paper-clip plane between said arc termination point and said first bend;
(c) slipping said papers into said gap; and
(d) releasing said paper clip, thereby permitting said arc termination point and said first bend to press against and retain said papers.
